(19) United States
(12) Patent Application Publication
(10) Pub. No.: US 2005/0230872 A1
(43) Pub. Date: Oct. 20, 2005

(54) Pellet mill and method of making peanut hull granules

(76) Inventors: Robert E. Scobee, Perrysburg, OH (US); Thomas F. Willard, Dothan, AL (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/090,759

(22) Filed: Mar. 25, 2005

Related U.S. Application Data
(60) Provisional application No. 60/556,497, filed on Mar. 26, 2004.

(51) Int. Cl. B29C 35/00

(52) U.S. Cl. 264/141; 425/406

(57) ABSTRACT

To make peanut hull granules peanut shells are supplied to a flaker where the shells are flaked. The flaked shells are fed into a hydraulic pellet press where they are pressed into pellets using a horizontal die. The pellets are then cooled using cooler. The cooled pellets are processed by a roller mill that crumbles the pellets into granules.

### CROSS REFERENCE TO RELATED APPLICATIONS

This application claims priority to U.S. Provisional Patent Application No. 60/556,497, filed Mar. 26, 2004, the entirety of which is hereby incorporated by reference.

### BACKGROUND

A major byproduct of the peanut industry is the hulls. Whole peanut hulls are produced in shellers' factories. As a result of government regulations, shellers are required to dispose of the hulls in an environmentally responsible manner, which includes shipment to a facility that can utilize the shells in commerce. Peanut hulls can be used for a variety of commercial products such as pet litter, mushroom growing medium, pesticide carrier, fertilizer carrier, mulch, fuel, fillers, spill absorbent, metal polish, charcoal briquets, and the like. See, W. J. Albrecht, “Peanut Hulls: Their Properties and Potential Uses,” U.S. Department of Agriculture, Science and Education Administration, Agricultural Reviews and Manuals, ARM-S-1/January 1979. Many of these products utilize peanut hulls which have been processed into granules that have a specified size distribution, density, and moisture content. The properties of the pellets and granules depend upon the quality of the peanut hull material used.

Peanut hulls comprise three parts: cellulose, which is the spongy part of the peanut shell, a matrix of fiber, and a glossy white or a glossy black liner comprising the inner skin of the peanut shell. Mixed in with the hulls are red peanut skins that fall off shelled peanuts.

The granule production process can be summarized by the following discussion. Prior to shipment, peanut shellers typically reduce the volume of their hulls, thereby increasing the density, often doubling the bulk density, in order to reduce shipping costs. Customarily, a hammer mill is used to grind the hulls into finer material.

As is customary in the use of such hammer mills, the hulls are moved through a screen having a round-shaped hole. A vacuum or negative air is applied to draw the hull material through the screen. The round-shaped surface of the resultant ground material facilitates the vacuum transportation of the material through the machine.

The ground material is then shipped to a prior art, commercial pelletizing facility, as disclosed in U.S. Pat. Nos. 5,041,410, 5,219,818, and 5,229,348, all issued to Ivie, which are incorporated herein by reference. At such a facility, the ground material is reground or milled through a screen using a full cycle hammer mill, preferably having 1/16 inch interstices, and passed through a screen opening no greater than 3/32 inch, thereby creating a powder. However, dust is also created by the hammer mill having such small interstices and screens to render the powder. This dust may also have a commercial use, but the creation of such dust can clog machinery, create adverse working conditions, and can lead to an inferior finished product.

Next, conventional pellet mills are employed to compact the ground hulls to create pellets. These mills utilize a ring-die configuration. In this configuration, the die is arranged on the circumference of a shaft, known as a quill. The die rotates vertically against a set of rollers. The die, which typically has a relatively large mass, is rotated at about 145-400 rpm. Rotation of such a large mass at this speed consumes a large amount of energy.

In operation, material is fed into tightly arranged rollers and gets pinched between the nip of the roller and the face of the die. As the die rotates away from the rollers, the material is expelled from the die from the centripetal acceleration of the material. In some applications, fixed knives are positioned around the dies that strike the material as it is expelled from the die, thus creating a random-length pellet. The variation in pellet length may range from the thickness of an aspirin to 1¼ inches.

Steam is introduced in a conditioner before the product enters the die, which heats up the die and the mixture. Volatile oils found in the peanut skin become tacky, and act as an adhesive to join together small pieces in the mixture, thereby forming a pellet. The pellets are then passed through a cooler to bring them down to ambient temperature.

Next, the pellets are fed into a conventional crumble roller. This conventional crumble roller has a mechanical gap set between two rollers with a different type of cut or configuration sliced into the rollers, e.g., a basic saw tooth configuration. Traditionally, a feeler gauge is used to mechanically set the gap between the rollers. The rollers have a tension spring to release larger materials that otherwise would not pass through the rollers. As the pellets pass through the rollers, they are fractured into granules.

Finally, the finished granular product is separated by size using shaker screens, preferably to remove residual dust created as a result of the crumble process. The removed peanut hull dust, like the dust created during the hammer mill portion of the process, is undesirable, as it can foul machinery, create a dusty working environment, and reduce the quality of the granular product.

Therefore, there exists a need in the commercial peanut hull processing industry for a peanut hull process that minimizes the amount of dust and other waste created from the shells. There is also a need to reduce the associated energy costs in the production of granular product. Finally, there is a need to increase granular product consistency.

### SUMMARY OF THE INVENTION

The system and method of the present invention has several advantages over the prior art. To make peanut hull granules peanut shells are supplied to a flaker where the shells are flaked. The flaked shells are fed into a hydraulic pellet press where they are pressed into pellets using a horizontal die. The pellets are then rapidly cooled using a counter flow cooler, thereby making the pellets brittle. The cooled pellets are processed by a roller mill that crumbles the pellets into granules. Finally, the entire process is monitored and controlled by a programmable logic controller, to increase the consistency of the resultant granules.

In one aspect, the present invention is directed to a method of producing pellets, comprising: reducing raw material into granular material; separating the granular material using a screen having openings about ⅛″ or larger into screened material; and compressing and extruding the screened material into pellets using a pellet press having a horizontal die.

In another aspect of the present invention, the raw material is organic material.

In another aspect of the present invention, the organic material is peanut hulls.

In another aspect of the present invention, the pellet press is hydraulic.

In another aspect, the present invention is directed to a method of producing peanut hull pellets, comprising: shredding peanut hulls into shredded material; separating the shredded material through a screen having openings larger than 3/32″ into screened material; and compressing and extruding the screened material into peanut hull pellets.

In another aspect of the present invention, said shredding is performed using a flaker mill.

In another aspect of the present invention, said compressing and extruding is performed using a horizontal die, hydraulic pellet press.

In another aspect, the present invention is directed to a method of producing pellets, comprising: shredding raw material into shredded material; separating the shredded material through a screen having openings about ⅛″ or larger into screened material; and compressing and extruding the screened material into pellets.

In another aspect of the present invention, said compressing and extruding is performed using a horizontal die, hydraulic pellet press.

In another aspect of the present invention, the raw material is organic material.

In another aspect of the present invention, the organic material is peanut hulls.

In another aspect, the present invention is directed to a method of creating peanut hull material for use in a pellet mill, comprising: shredding peanut hulls into shredded material using a flaker mill; and separating the shredded material through a screen having openings at least ⅛″ into screened material.

In another aspect, the present invention is directed to a mill, which produces granules, comprising: a shredder which shreds raw material into shredded material and separates the shredded material through a screen having openings about ⅛″ or larger into screened material; and a horizontal die, hydraulic pellet press, which compresses the screened material into pellets.

In another aspect of the present invention, the raw material is organic material.

In another aspect of the present invention, the organic material is peanut hulls.

In another aspect of the present invention, the mill further comprises: a crumble mill which crumbles the pellets into granules; a plurality of shaker screens to separate the granules by size; a conveyor which transports the screened material from the shredder to the pellet press, the pellets from the pellet press to the crumble mill, and the granules from the crumble mill to the shaker screens; at least one gamma ray weight measuring apparatus, which continuously measures one or more of weight, density and volume of the granules; and a computer adapted to collect process data from and control process parameters of the shredder, the pellet press, the crumble mill, and conveyor.

In another aspect of the present invention, the mill further comprises: a second gamma ray weight measuring apparatus, which continuously measures one or more of weight, density and volume of the pellets, wherein the computer collects data from the second gamma gamma ray weight measuring apparatus and adjusts the horizontal die, hydraulic pellet press based in part on the density of the pellets.

In another aspect of the present invention, the pellet press further comprises a die having an effective ratio from 8:1 to 5.375:1.

In another aspect of the present invention, the die has an effective ratio of 6.25:1.

In another aspect of the present invention, the mill further comprises: a programmable logic controller that monitors and controls hydraulic pressure supplied to the horizontal die, hydraulic pellet press.

The invention will now be described in more detail with reference to the drawings.

### IN THE DRAWINGS

FIG. 1 shows an embodiment of the invention;

FIG. 2 shows an embodiment of a horizontal die press;

FIG. 3 depicts a horizontal die;

FIG. 4 depicts a conical roller on a horizontal die; and

FIGS. 5A and B depict die specifications for two exemplary dies.

### DETAILED DESCRIPTION

The present method and system overcomes the deficiencies of the prior art in several ways. In a preferred embodiment, the system comprises a proprietary shredder, known as a flaker mill, a programmable logic controller (PLC), a horizontal die, hydraulic pellet press, a crumble mill, a plurality of shaker screens, conveyors, and a plurality of gamma-ray weight measuring apparatuses. The disclosed system processes peanut hulls to produce a granular product having a consistency which is superior to that disclosed by the prior art.

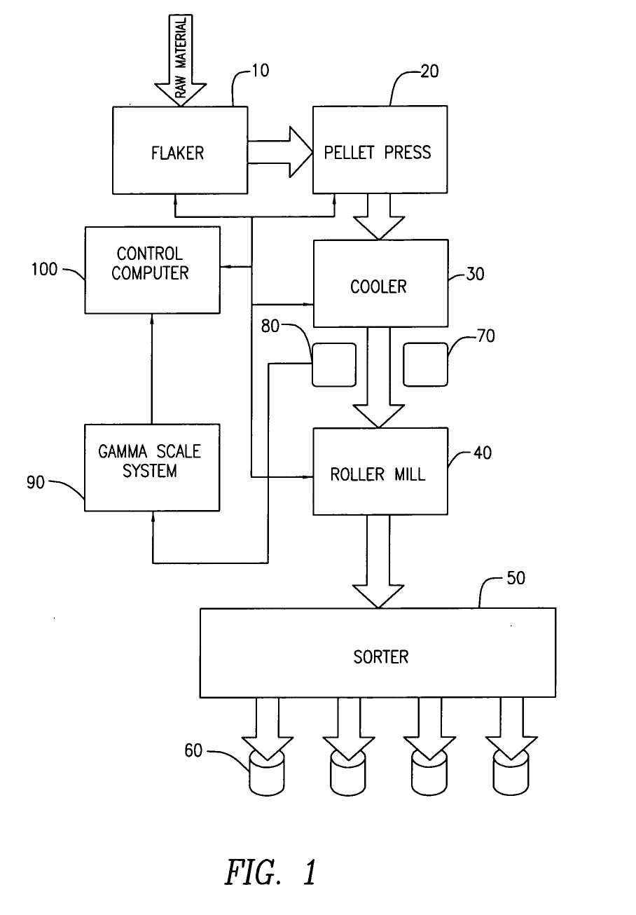

FIG. 1, shows one embodiment of the invention. Raw materials, in this case peanut shells, are supplied to flaker 10 where the shells are flaked. The flaked shells are fed into horizontal die, hydraulic pellet press 20 where they are pressed into pellets. The pellets are then cooled using cooler 30. The cooled pellets are next processed by roller mill 40. Roller mill 40 crumbles the pellets into granules. The granules are sorted by size in sorter 50 and collected, by size, in bins 60. In one embodiment, density of the granules is monitored using a gamma radiation source 70, detector 80 and measurement computer 90. It should be noted that measurements can be taken at any point in the process. Data from each component of the system are input into control computer 100. Control computer 100 monitors and controls the flaker 10, the pellet mill 20, the cooler 30, and roller mill 40. A plurality of programmable logic controllers (PLCs) are used in the system. Each component can be controlled using a PLC. In one embodiment, control computer 100 controls each PLC.

As shown in FIG. 1, unground peanut hulls are the raw materials input into proprietary flaker mill 10 to be ground. In this process, raw hull material is fed into the flaker 10 which shreds the hulls into smaller pieces. The shredded hulls are shaped and sized by a screen used in the flaker. The flaker preferably utilizes a screen having square shaped holes of about ⅜ inch wide, however, different hole shapes and sizes may also be used.

The shredded material is then separated through a screen with about ⅛″ inch openings or larger and preferably about ¼ inch openings or larger. In an alternative embodiment, the screen openings may be larger than 3/32 inch. Screens with smaller openings, while they may be used, are more likely to produce dust. The screened material is air-blown into a pellet press hopper for the next step of the process. In one embodiment a vibratory feeder is used.

The flaker 10 has three advantages over the hammer mills used in the prior art. First, the flaker 10 yields material having a more uniform size. Second, fewer small particles are produced. These small particles, known as fines or dust, are particles that would pass through a 40 mesh standard screen. Fines or dust fed into the pelletizing machine lead to inconsistently sized granules upon crumbling, and therefore more waste product. Third, this shredding process requires less horsepower, i.e. less energy, and is therefore less expensive to operate than the prior art hammer mill.

Alternatively, shellers may provide pre-ground hulls for use in this process. Preferably, such pre-ground material should be produced on a hammer mill having a 5/32 inch screen on the grinding side and a 3/16 inch screen on the back side. In this instance, the hull material need not be reground, but may be placed directly in the pellet press hopper.

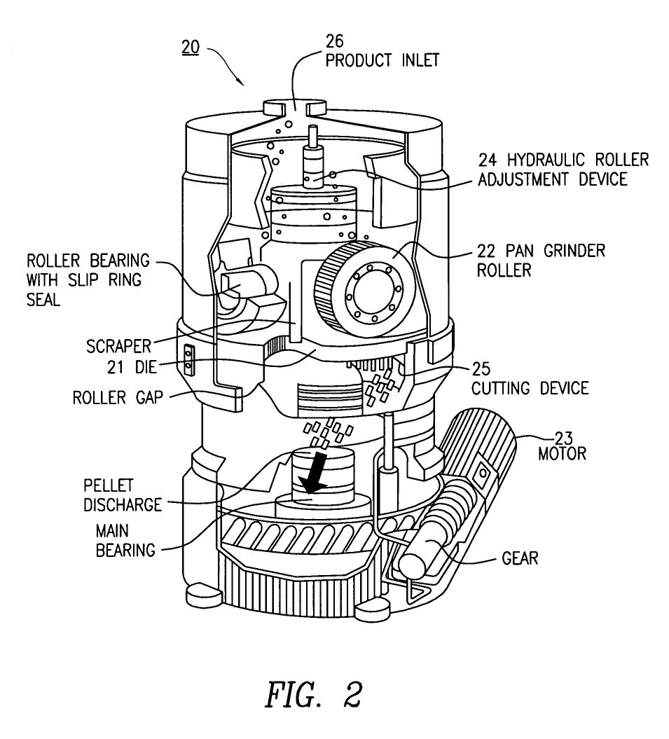

The ground hulls are converted to pellets using a pelletizing machine 20, known as a die press machine. In a preferred embodiment, shown in FIG. 2, the pelletizing machine is PLC controlled. This machine has been used for pelletizing wheat, straw, and for reclaiming sawdust in the wood industry, making a so-called range cube, which may be used in the fossil fuel industry. It has also been used in a variety of other applications, however, it has not been previously used to process peanut hull material.

The pellet press 20 has a horizontal fixed die 21, which achieves an unparalleled throughput. In this embodiment of the machine, four horizontal rollers 22 are arranged in a radial direction around a vertical shaft, like spokes of a wheel, and are attached to the shaft. A motor 23, coupled to a gear box at the base of the machine, provides the rotational force to the shaft, through the gear box, necessary to rotate the shaft at about 72 to 74 rpm. In one embodiment, the gear box includes a worm-gear that provides the necessary driving force. The roller assembly is attached to a computer controlled hydraulic jack 24, which maintains downward pressure on the rollers. The downward pressure is controlled based on data input into control computer 100. A series of knives or cutters 25 are attached to the vertical shaft underneath the die 21. Cutters 25 cut the material off at a fixed length as the material is extruded through die 21.

In operation, raw material is gravity fed into the pellet press 20 via a product inlet 26 above the die. In one embodiment, the raw material is fed into the hopper using a vibratory feeder. As the vertical shaft of the press 20 is turned, the rollers 22 pass over fixed die 21 and press the material through the die. When the mixture is pressed into die 21, heat is generated by the friction of squeezing the material at extreme compaction ratios. Steam is also admitted into the press to further heat die 21. As the mixture comes in contact with the heated die, the mixture gets scorched and forms a layer. As each layer pushes out of the die, a laminated pellet is created. This method is in contrast with the prior art method of adding steam or water to the mixture prior to extrusion, thereby forming a so-called caked pellet.

As the material is pressed through the die, the knives pass underneath the die, cutting off a length of extruded material, thereby forming pellets. The knives are attached to the same shaft as the rollers which extrude the material through the die. The knives are at a fixed operating angle, or dwell angle, behind the rollers, and shear off the pellet at a precise length. The length of the pellet coincides with finished granular product described below. Discharge wiper blades move the material out of the machine and on to the cooler.

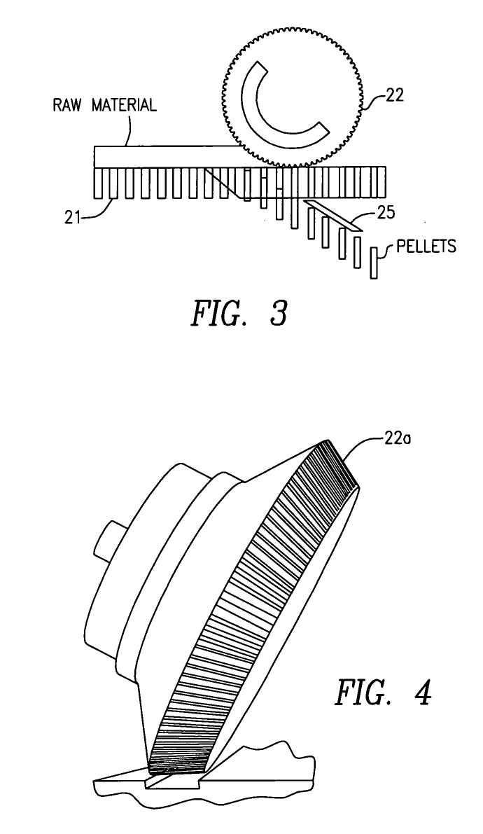

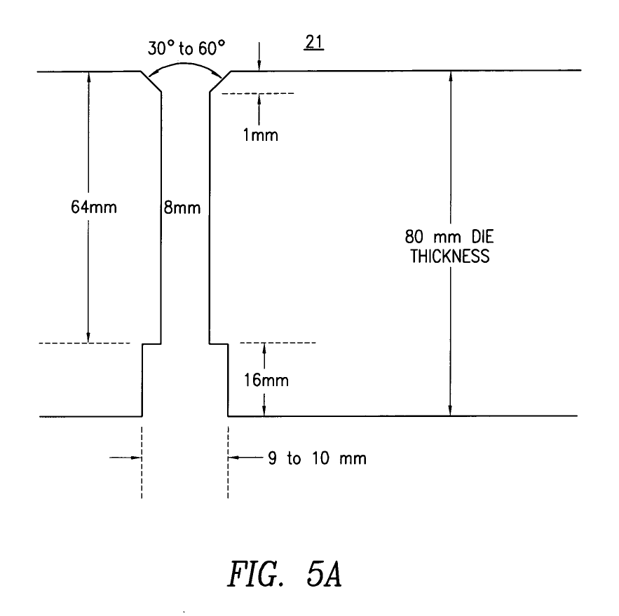

FIG. 3 is a detail depiction of the pelleting and cutting portion of the press 20 in FIG. 2. As shown, the raw material rests on die 21. Die 21 rotates such that the raw material is presented to grinder roller 22. Roller 22 forces the raw material through the die. The heat generated during the pelleting process and steam introduced to the die 21 laminates the pieces of raw material together. The raw material is extruded through the die and cut off into substantially equal size pellets by cutting tool 25. Due to the known rate of extrusion, the cutting tool can be placed such that a desired length pellet is achieved. In one embodiment, in place of the straight roller 22 shown in FIGS. 2 and 3, a conical roller 22a, as shown in FIG. 4, is used.

A pellet discharge chute is arranged beneath the knives to catch the extruded pellets. Cooler 30 then cools the pellets down.

In a preferred embodiment, the pellets, are weighed using a gamma ray weight measurement device 70, 80, 90. Such a device has been commonly used in the pet food industry. This device provides a means for measuring weight, density, or volume of the pellets as they are expelled from the pelletizing machine. In another embodiment, the density of the granules can be measured as they are expelled from sorter 50.

In operation, device 70 a gamma ray source, passes gamma rays through the bulk of the product. Sensor 80, on the other side of the product, measures the strength of the signal coming through the product. The device correlates the absorbed rays as an indication of the density of material that is passing in front of the sensor 80.

Pellets can be supplied to industry in pellet form or they may be further processed by fracturing or crumbling them up to form a desired end product. This is achieved by passing them through the conventional crumble mill and screening equipment described above, which is widely used throughout the world in similar applications, and is available from multiple industry suppliers. The fractured pellet material is then screen classified by sorter 50, based on size, to meet customer demands, and weighed using the gamma ray device described above.

Process automation computer 100 in communication with one or more PLCs and other data gathering and process control devices are used to control machinery and machine parameters used throughout the process, including the flaker 10, hydraulic die press adjuster 240 pressure, and the gap of crumble roller 40. In addition, the computer collects data from various sensors monitoring the process, including the densities measured by the gamma ray device or devices. In one embodiment, the process automation computer also continuously monitors production rates, product quality parameters, and equipment operation.

In contrast to prior art ring-die configured machines, the inventors have discovered that a horizontal die press machine has less wear, produces less heat, and consumes less energy. This die press is superior, in part, because the die, which typically has a relatively large mass, does not move. Thus, the rotational speed of the rollers is much slower. It has been observed that, for a given die size, an approximately 40% increase in throughput has been achieved with an approximately 50% reduction in energy usage. This die press machine also produces a more uniform and consistent pellet.

An additional advantage of pellet press 20 is that it does not utilize mechanical shear pins to limit the pressure of the rollers on the die, which is a common practice in most conventional mills known and used in the prior art. Instead, hydraulic pressure applied to the rollers, monitored with sensing devices, and is controlled in one embodiment by a programmable logic controller (PLC).

Pellet press 20 provides the ability to influence the density of the pellets, and therefore the density of the finished product, by increasing or decreasing the hydraulic pressure applied to the rollers. Very critical tolerances can be achieved using this configuration improving the uniformity of the resultant pellets. Additionally, depending on the dimensions of the die used, the so-called die specifications, the density of the finished product can also be changed. Forcing the material through the die promotes a chemical change in the materials by the application of heat and friction. Different die specifications change the compression of the material and the amount of time that the material is compressed, known as the dwell time. Pellet press 20 provides an added advantage in that the die can be changed in a relatively short duration of time compared to changing the die in vertical die presses known and used in the prior art.

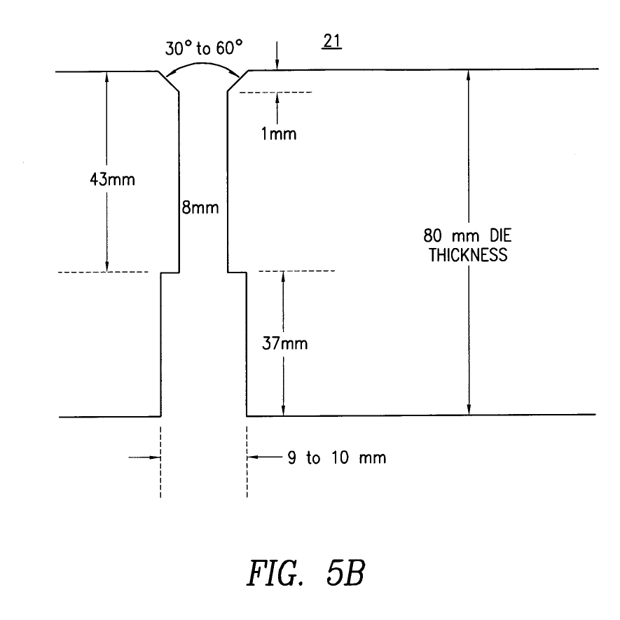

FIGS. 5A and 5B illustrate two exemplary dies 21 used in pellet press 20. The effective ratio is the length of the compression portion of the die, divided by the diameter of the compression portion. The compression portion of the die is approximately the thickness of die 21, minus the length of the relief area, and is representative of the dwell time.

FIG. 5A illustrates an 8:1 effective ratio die. As shown in FIG. 5A, an 80 mm thick die preferably comprises a chamfered inlet, a 64 mm compression portion having an 8 mm diameter, and a 16 mm long relief area. The chamfer is preferably 30 to 60 degrees, and 1 mm thick. The diameter of the relief area is preferably 9 to 10 mm.

FIG. 5B illustrates a die having an effective ratio of 5.375:1. This 80 mm thick die preferably comprises a chamfered inlet, a 43 mm compression portion having an 8 mm diameter, and a 37 mm long relief area. The chamfer is preferably 30 to 60 degrees, and 1 mm thick. The diameter of the relief area is preferably 9 to 10 mm.

Die selection is based on pellet bulk density at a desired throughput rate. The effective ratio of a preferable die varies from 8:1, where maximum compaction dwell time occurs, to 5.3:1, where a minimum dwell time occurs. Preferably, an established pellet standard has a bulk density of 40 #/cu. ft. at a throughput rate of 8 tons per hour. The most preferable die that achieves the standard bulk density at the desired throughput has a 6.25:1 effective ratio. At the present time, selection of the proper die is influenced by a multitude of factors such as the type of material, moisture content, etc., as explained below. Die selection is largely determined by experience and the quality of output product. For example, if the output pellet has a bulk density that is too low, then a die having a larger effective ratio than the current die is chosen to raise the bulk density within a preferred range of 36 to 44 #/cu. ft. If the throughput of the pellets is less than the desired 8 tons/hr, then the die is changed to one having a smaller effective ratio than that currently used.

Another advantage of pellet press 20 over the prior art is the system's ability to produce pellets of a precision length. In the prior art, pellets have a random length from about 3/16 inch to 1¼ inch, which in turn will produce randomly-sized granules when run through the crumble mill. In contrast, the precision length pellets produced by the present invention, when crumbled into a granular product, reduces the amount of granular product that falls outside of specified tolerances, thereby increasing throughput coming out of the screening process. In addition, the granules will have greater consistency in density. Additionally, the consistency of the flaked material adds to the consistency of the finished granulated product.

An additional advantage is the ability to correlate the granule size with the size of the material produced by flaker mill 10 and the hydraulic die pressure used to produce the pellet. A gamma ray device continuously weighs the finished granular product as it is being produced. Production data is fed back to the process automation computer. Computer 100 trends production data and ultimately creates a recipe for the finished product. By automating data collection of the system's performance and by controlling process parameters, process computer 100 can develop a recipe for a desired finished product. Such a recipe produces a consistent, precise product.

Computer 100 uses the trends built from process runs to determine each recipe. The recipe comprises process parameters, such as the hydraulic die pressure and the gap between the crumble mill rollers. The computer adjusts these parameters to ensure that the finished product meets the desired specifications for each recipe.

Another advantage of the present system is process computer 100's ability to monitor deviations in the specified product and to alert an operator when problems arise. Process computer 100 adjusts parameters, based on differences in the raw material used, to produce the desired end product, as explained above. Since peanut hulls are a natural resource that are typically harvested in the fall of the year. There are numerous varieties and growing conditions involved. The peanuts can be stored in a warehouse for varying lengths of time, perhaps up to 10 months, until they are shelled. There can be wide variations in the hull material based on many of these factors. Hull degradation due to storage plays a important role in the processing of hulls. Hulls that are received at harvest time are somewhat moist and green. But, towards the end of the shelling year, a significant amount of degradation will occur. With the present invention, particularly-sized screens are used in flaker mill 10. For example, degraded shells are milled with a much larger screen than those used when the harvest is fresh. Consequently, less time will be spent in flaker mill 10 using the larger screen size, thus improving throughput. The balance of the plant can be adjusted to accommodate the differences from variations in the material, so that the finished product still meets the desired specifications.

Another advantage of the present system and method is, that by producing a consistent particle size out of flaker mill 10 before the material is pressed and crumbled, the resultant granule that comes out of roller mill 40 has a greater resistance to attrition.

The present system and method also provides a manufacturing flexibility to produce product in accordance with customer specifications. For example, if an order is received for a Size Guide Number (SGN) 100-type product, sorter 50's screens can be replaced with a size that yields the proper size finished product after it's been pressed and crumbled. In addition, hydraulic die press 20 applies the exact pressure to produce a pellet, which will crumble into the SGN 100-type product.

Having thus described at least illustrative embodiments of the invention, various modifications and improvements will readily occur to those skilled in the art and are intended to be within the scope of the invention. Accordingly, the foregoing description is by way of example only and is not intended as limiting. The invention is limited only as defined in the following claims and the equivalents thereto.

1. A method of producing pellets, comprising:
reducing raw material into granular material;
separating the granular material using a screen having openings about ⅛″ or larger into screened material; and
compressing and extruding the screened material into pellets using a pellet press having a horizontal die.

2. The method of claim 1, wherein the raw material is organic material.

3. The method of claim 2, wherein the organic material is peanut hulls.

4. The method of claim 1, wherein the pellet press is hydraulic.

5. A method of producing peanut hull pellets, comprising:
shredding peanut hulls into shredded material;
separating the shredded material through a screen having openings larger than 3/32″ into screened material; and
compressing and extruding the screened material into peanut hull pellets.

6. The method of claim 5, wherein said shredding is performed using a flaker mill.

7. The method of claim 5, wherein said compressing and extruding is performed using a horizontal die, hydraulic pellet press.

8. A method of producing pellets, comprising:
shredding raw material into shredded material;
separating the shredded material through a screen having openings about ⅛″ or larger into screened material; and
compressing and extruding the screened material into pellets.

9. The method of claim 8, wherein said compressing and extruding is performed using a horizontal die, hydraulic pellet press.

10. The method of claim 8, wherein the raw material is organic material.

11. The method of claim 10, wherein the organic material is peanut hulls.

12. A method of creating peanut hull material for use in a pellet mill, comprising:
shredding peanut hulls into shredded material using a flaker mill; and
separating the shredded material through a screen having openings at least ⅛″ into screened material.

13. A mill, which produces granules, comprising:
a shredder which shreds raw material into shredded material and separates the shredded material through a screen having openings about ⅛″ or larger into screened material; and
a horizontal die, hydraulic pellet press, which compresses the screened material into pellets.

14. The mill of claim 13, wherein the raw material is organic material.

15. The mill of claim 14, wherein the organic material is peanut hulls.

16. The mill of claim 13, further comprising:
a crumble mill which crumbles the pellets into granules;
a plurality of shaker screens to separate the granules by size;
a conveyor which transports the screened material from the shredder to the pellet press, the pellets from the pellet press to the crumble mill, and the granules from the crumble mill to the shaker screens;
at least one gamma ray weight measuring apparatus, which continuously measures one or more of weight, density and volume of the granules; and
a computer adapted to collect process data from and control process parameters of the shredder, the pellet press, the crumble mill, and conveyor.

17. The mill of claim 16, further comprising:
a second gamma ray weight measuring apparatus, which continuously measures one or more of weight, density and volume of the pellets,
wherein the computer collects data from the second gamma gamma ray weight measuring apparatus and adjusts the horizontal die, hydraulic pellet press based in part on the density of the pellets.

18. The mill of claim 13, wherein the pellet press further comprises a die having an effective ratio from 8:1 to 5.375:1.

19. The mill of claim 18, wherein the die has an effective ratio of 6.25:1.

20. The mill of claim 13, further comprising:
a programmable logic controller that monitors and controls hydraulic pressure supplied to the horizontal die, hydraulic pellet press.
